(19) United States
(12) Patent Application Publication
(10) Pub. No.: US 2018/0072043 A1
(43) Pub. Date: Mar. 15, 2018

(54) HEATED IRON OR ROLLER FOR A TEXTILE PRINTING APPARATUS

(71) Applicant: M&R Printing Equipment, Inc., Roselle, IL (US)

(72) Inventors: Richard C. Hoffman, JR., Lake Forest, IL (US); Andrew L. Oleson, Carol Stream, IL (US); Darek Tkacz, Naperville, IL (US)

(21) Appl. No.: 15/699,555

(22) Filed: Sep. 8, 2017

Related U.S. Application Data
(60) Provisional application No. 62/385,459, filed on Sep. 9, 2016.

(51) Int. Cl. B41F 15/44; B41F 16/02; B41F 15/14; B41F 15/08

(52) U.S. Cl. CPC B41F 15/44; B41F 15/0804; B41F 15/14; B41F 16/02

(57) ABSTRACT

The present invention provides a fabric compressor for applying heat and or pressure to a textile before or after applying ink to a textile during a screen printing operation to prevent fibrillation, to provide a smooth base coat, and/or to cure ink.

### CROSS-REFERENCE TO RELATED APPLICATIONS

The present invention claims the benefit of U.S. Provisional Patent Application No. 62/385,459 filed Sep. 9, 2016, the contents of which are incorporated herein by reference.

### FEDERALLY SPONSORED RESEARCH OR DEVELOPMENT

N/A

### FIELD OF THE INVENTION

The present invention is directed to a fabric compressor having a heated flat iron or a heated roller for use in treating a textile prior to or during a screen printing operation.

### DESCRIPTION OF THE PRIOR ART

Screen printing is an art form that is thousands of years old and involves depositing ink on a screen with a pattern thereon and squeegeeing the ink so that it passes through the screen onto the item such as a textile to bear the pattern. Screen printing is commonly used for decorating clothing such as T-shirts, pants, and other items like hand bags and totes, with slogans, college names, sports team, trademarks and the like. The indicia can include either simple one-color block letters or elaborate multi-color illustrations.

In common use in the silk screening industry are a multi-station turret type (U.S. Patent Publication No. 2011/0290127) and oval-type (U.S. Patent Publication No. 2010/0000429) printing presses (both of these patent applications are incorporated herein by reference and made a part hereof). These printing presses have a plurality of flat beds or platens spaced along their perimeter, one for each color. The number of stations employed depends on the number of colors to be printed on the object. Indicia can consist of up to ten colors or more.

One significant challenge in screen printing is the time necessary to prepare each screen. The general process for setting-up the screens for printing follows: First, the artwork is set up. The artwork, in the form of a film positive, is secured on a layout board. Next, a carrier sheet (optically clear polyester film) is placed on the layout board. An individual separates the colors by transferring the artwork by hand to one or more carrier sheets. In this separation/transference process, each carrier sheet represents a separate color to be used in the final screened textile. Thus, if there are six colors being screened, there will be six carrier sheets (art separations) completed.

Second, the stenciled screens are made by covering the mesh of the screen with an ultraviolet sensitive emulsion. Each carrier sheet is aligned with such an emulsion covered screen and placed in a vacuum exposure unit with a UV light source such that the carrier sheet is disposed between the light source and the screen. The screen/carrier sheet combination is subjected to a vacuum, to bring them into contact with one another, and exposed to UV light. The carrier sheet prevents the underlying emulsion from curing. When the exposed screen is washed with a high pressure spray of water, the uncured portions underlying the carrier sheet wash away leaving an open mesh while the portions of the screen not covered by the carrier sheet are cured and do not wash away and leave a closed mesh.

Third, each printing screen is secured to a printing head. One color of ink is then placed into each printing head. With all of the screens mounted to a printing press, textiles are loaded, one at a time, onto the travelling pallets and the pallets travel to each of the printing stations where an ink of a single color is applied to the textile. Each printed textile is cured typically by applying heat with a dryer.

There are several types of ink that are used for textile printing including water-based inks, plastisols and sublimation inks. Water-based inks utilize either dyes or pigments in a suspension with water as the solvent. The evaporation of the water is necessary to set or cure the ink. This curing can take place either at room temperature or using a forced-air dryer depending upon the specific water-based ink used and the speed or volume of production. While water-based inks are defined as those that utilize water as the main solvent, they can contain co-solvents which are petroleum based. Many water-based inks can also be more quickly cured with the addition of a catalyst. The disadvantage of a catalyst is that once it is added to a water-based ink, it creates a time limit or pot life where the ink must be all used in a certain time or be discarded.

Plastisol inks contain poly(vinyl chloride) and little or no solvent. Along with UV inks used in graphic screen printing, it is referred to as a 100% solid ink system. Plastisol inks are cured by exposure to temperatures in the range of about 320° F. to about 350° F. for a period of five to ten minutes or more which causes PVC to crosslink and solidify. In the ranges below 320° F. and above 350° F., the plastisol will not properly set, resulting in cracking, or it may become liquefied. Moreover, if a dye in the textile is overheated, it will migrate, or the textile or substrate may scorch or burn, increasing waste and production costs. Plastisol inks are available in various opacities with the most opaque being the most expensive, mainly due to the cost of the increased pigment.

Water based inks containing acrylics are also commonly used in screen printing and must be cured by exposure to heat for a period of time. Discharge inks are water-based inks for screen printing. The inks are mixed with an activator such as formaldehyde and a pigment and are used with cotton containing textiles and no base coat is required. Discharge inks are cured by heating to 320° F. for a sufficient period of time to evaporate the water and to discharge the ink into the fibers of the textile.

Sublimation inks are water based inks for direct to garment printing using a digital printer and have to be heated to cure the ink to about 320° F.

A common challenge to screen printers is fibrillation—a condition that occurs when substrate fibers from a screen-printed garment break loose from the ink film printed on the garment. Fibrillation can occur immediately after printing or after laundering one or more times. Fibrillation causes the garment to appear washed out or faded over the entire garment. Customers who purchase printed textiles from a screen-printing company and experience fibrillation can lead to them rejecting a print job with a corresponding loss of revenue to the screen-printing company. Detecting the cause of fibrillation can be difficult due to numerous factors such as the material composition of the garment, the type of ink, a printing press operating parameter or setting, a dryer setting, and combinations of the same. Therefore, the problem can be difficult to resolve and can result in a significant loss of revenue and good will of a printing business.

Another problem encountered in screen printing to garments occurs when a printed garment has a rough texture or hand feel on the printed area of the garment. Prior attempts to overcome this problem of uneven print surfaces using, for example, squeegees of varying durometer, do not always solve the problem. Achieving a smooth ink surface can be difficult to achieve but is important to maintaining high quality printed garments.

International Publication No. WO 2008/020777 discloses a press with a pressing roll for transferring a motif from a carrier foil onto an underlying garment. The press is mounted to an existing printing machine in place of a standard screen printing head. The press has a generally rectangular frame for mounting to an arm of the screen printing machine defining a printing area. An inflatable cloth is placed in the printing area and lies between the pressing roll and the substrate to be decorated. A set of feeder rollers are mounted on one lateral edge of the frame and a set of take-up rollers are mounted on an opposed lateral edge of the frame. Foil is drawn by the take-up rollers from the feeder rollers through the printing area and under the inflatable cloth and in contact with the substrate to be decorated. The thermal cloth is inflated to stretch the foil to eliminate any wrinkles and the pressing roll is activated to pass between end edges of the frame in a direction orthogonal to the printing press support arm. Heat is applied by the inflatable cloth or the pressing roll and pressure is applied by the pressing roll to adhere the motif to the substrate. After the motif has been transferred, the inflatable cloth is deflated and the take-up rollers rotate to give the foil some slack. Compressed air is then provided to form an air pocket between the substrate and the film to separate the foil from the motif and substrate. Upon separation, the take-up rollers are then rotated in the opposite direction to draw the used foil onto the rolls for later disposal or recycling and to pull unused foil from the feeder rollers into the printing area for the next application.

One attempt to address fibrillation comes in the form of a heated flat iron mounted to an arm of a screen printing press for reciprocating translational motion over a screen surface to deliver heat and pressure to an underlying textile supported by a pallet of the press. This product is sold under the name ROQpress Iron. Applicant is not aware of a ROQpress Iron that is suitable for a stand-alone assembly not associated with a printing press or one that is suitable for direct contact with a textile.

### SUMMARY OF THE INVENTION

The present invention provides a fabric compressor for use with a screen printing press having a squeegee mounting bar. The fabric compressor has a housing having a roller and an attachment member for mounting the housing to the squeegee mounting bar. The housing is mounted to the squeegee bar for reciprocal translational motion along a first line between a first location and a second location. The housing is also capable of reciprocating movement along a second line generally perpendicular to the first line between a disengaged position and an engaged position. When in the engaged position the roller is in direct contact with a textile or is in sufficient proximity to heat the substrate without the use of a screen interposed between the roller and the textile. The fabric compressor also has a heater element connected to the housing for heating the roller, and a control unit connected to the heater element having an input area and a status area. The input area has controls for setting a desired temperature of the roller. The status area has a display for indicating the actual temperature of the roller.

The present invention also provides an assembly for treating a textile before or during a screen printing operation. The assembly has an object support for supporting a textile and a bar extending across a portion of the object support. A fabric compressor is mounted to the bar for reciprocating translational motion along a portion thereof, the fabric compressor having a roller facing the object support. The assembly also has an optional first member for moving the fabric compressor automatically between a first position and a second position along the bar, and an optional second member for automatically moving the fabric compressor or the object support along a line generally perpendicular to the bar from a disengaged position to an engaged position. The first and second members are not required for manually operated fabric compressor assemblies. The assembly has a heater element connected to the roller and a temperature sensor connected to the roller. A control unit is connected to the heater element. The control unit has an input area and a status area. The input area has controls for setting a desired temperature of the roller and the status area has a display representing the actual temperature of the roller. The control unit is capable of generating a signal to the heater element to maintain the roller at the desired temperature.

The present invention further provides a printing press for screen printing. The printing press has an endless conveyor mounted for indexed movement about a first axis of rotation and a plurality of object supports for supporting a textile connected to the endless conveyor and for indexed movement with the conveyor. A plurality of print stations are spaced from one another about the conveyor and are positioned adjacent thereto. A fabric compressor is mounted adjacent a print station to a bar for reciprocating translational motion along a portion of the bar above one of the plurality of object supports. The fabric compressor has a roller facing the object support to contact the textile or to be in sufficient proximity to heat the textile. The press has a first member for moving the fabric compressor between a first position and a second position along the bar and a second member for moving the fabric compressor or the one object support along a line generally perpendicular to the common plane from a disengaged position to an engaged position. The press has a heater element connected to the roller and a temperature sensor connected to the roller. The press has a control unit connected to the heater element. The control unit has an input area and a status area. The input area has controls for setting a desired temperature of the roller and the status area has a display representing the actual temperature of the roller. The control unit is capable of generating a signal to the heater element to maintain the roller at the desired temperature.

The present invention further provides a method of pressing a textile on a screen printing press. The method includes the steps of: (1) providing a textile on an object support surface; (2) providing a fabric compressor station having a bar extending across a portion of the object support, a fabric compressor mounted to the bar for translational motion along a portion thereof, the fabric compressor having a roller facing the object support; (3) providing a first member for moving the fabric compressor between a first position and a second position along the bar; (4) providing a second member for moving the fabric compressor or the object support along a line generally perpendicular to the bar from a disengaged position to an engaged position; (5) providing a heater element connected to the roller; (6) providing a temperature sensor connected to the roller; (7) moving the object support into the fabric compressor station; (8) moving the roller with the second member into contact with or close proximity to the textile to heat the textile; and (9) moving the roller with the first member along the textile from the first position to the second position.

### BRIEF DESCRIPTION OF THE DRAWINGS

To understand the present invention, it will now be described by way of example, with reference to the accompanying drawings and attachments in which:

FIG. 1 is perspective view of a prior art screen printing press manufactured and sold by the M&R Companies, the assignee of the present invention, under the tradename SPORTSMAN® EX.

FIG. 2 is perspective view of a prior art screen printing press manufactured and sold by the M&R Printing Company, the assignee of the present invention, under the tradename STRYKER™.

FIG. 3 is a perspective view of a fabric compressor with a roller in accordance with the present invention.

FIG. 4 is perspective view of a fabric compressor with a flat iron in accordance with the present invention.

FIG. 5A is a side elevation view of a fabric compressor mounted for reciprocating translational movement over an object support in a first location and disengaged from the support.

FIG. 5B is a side elevation view of a fabric compressor mounted for reciprocating translational movement over an object support in a position engaging the object support and between a first location and a second location.

FIG. 6 is perspective view of a fabric compressor mounted to a screen printing press as a fabric compressor station among other stations such as printing stations, curing stations or other stations.

FIG. 7 is a schematic view of a control unit for entering and displaying operating parameters of the fabric compressor of the present invention.

FIG. 8 is a flow chart of the steps of a method of pressing a textile on a screen printing press.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

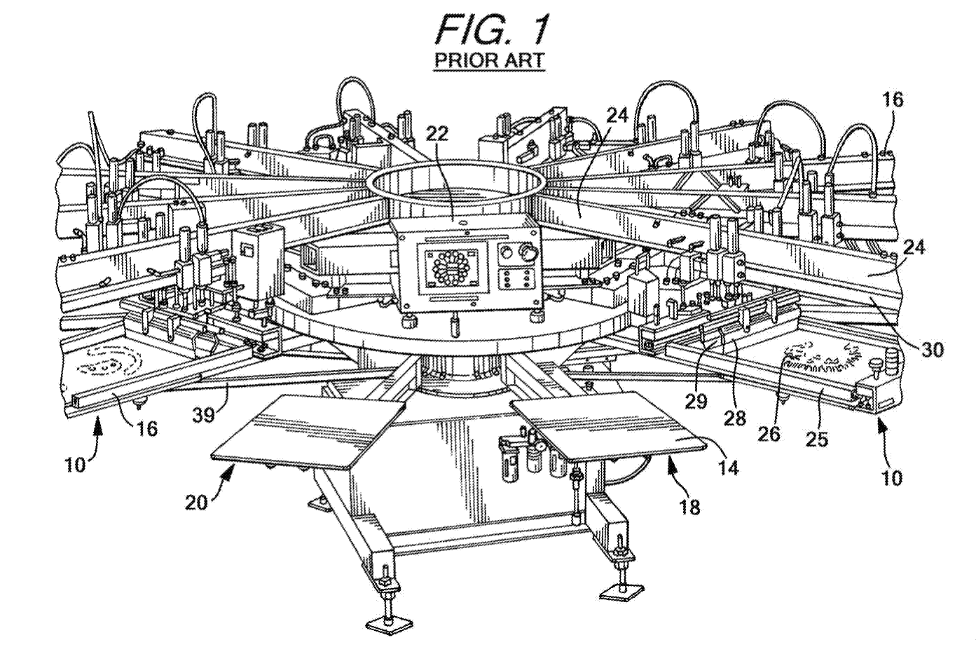

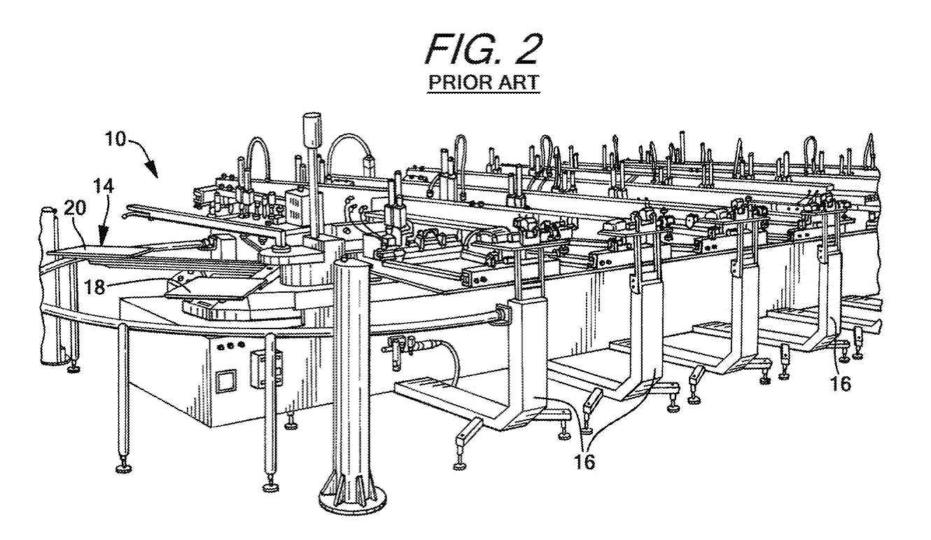

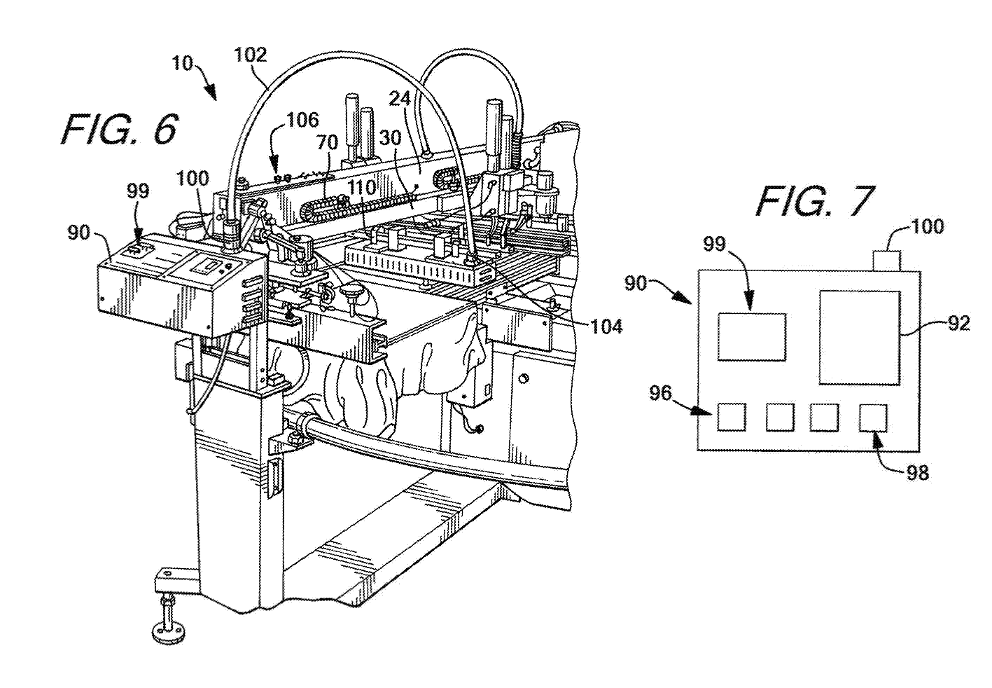

FIGS. 1 and 2 show prior art screen printing machines 10 one having a circular track 12 or rail (FIG. 1) and the other an oval track 12 or rail (FIG. 2). An endless conveyor is mounted for movement about an axis of rotation of the track in a clockwise or counterclockwise direction. A plurality of object supports 14 are attached to and extend radially away from the conveyor and move therewith through a common horizontal plane (i.e., the same distance above the surface supporting the press). Textiles are loaded on to the object supports and are moved with the conveyor from station 16 to station 16 in an indexed fashion and pause at each station for a sufficient period of time for a printing operation, or other operation, to be performed. The conveyor is moved by a motive source such as an electric motor and the movement is controlled by an indexer control mechanism to set the speed of rotation and the period at rest at each station. There are a variety of station types including a screen printing station 16, an ink drying or curing station, a loading station 18, an unloading station 20 and other stations to serve other purposes that are well known to those of ordinary skill in the art. The present invention provides a fabric compressor station that can be independent of the printing press as shown in FIGS. 5A,5B or can be one of the stations of the screen printing press 10 as shown in FIG. 6.

A screen printing station has a head assembly having an arm 24 pivotally connected on a frame 22 to overlie a pallet 14 and is mounted for movement between a printing position and a non-printing position. The printing head 24 includes a screen frame 25 for supporting a printing screen 26 that has a desired pattern for printing a white base coat or other desired color. Each station prints a single color. A squeegee 28 and a flood bar 29 are movably mounted to a squeegee bar 30 mounted to the arm 24 for traversing a printing stroke when the head assembly is disposed in the printing position and a flood stroke when the head assembly is in the non-printing position. The printing stroke requires moving the squeegee 28 and the flood bar 29 from a first position to a second position, and the flood stroke requires moving the squeegee and the flood bar from the second position to the first position. The movement of the squeegee and flood bar is accomplished using a pneumatic controls and is well known to those of skill in the art or manually by an operator of the press. As will be discussed below, these controls can also be used to control the movement of the fabric compressor assembly of the present invention.

Operatively connected to the frame of the head assembly are one or more locating bars 39 which are cooperatively associated with the object supports so as to ensure proper registration of the object supports when the printing head assembly is disposed in the printing position. The conveyor is driven on its endless path by a drive mechanism such as a chain or belt which is threaded about a sprocket journaled on a main drive shaft which is coupled in driving relationship to a drive motor. Operatively associated with the drive mechanism is an indexing system to effect an intermittent indexing of the respective object supports from station to station during machine operation.

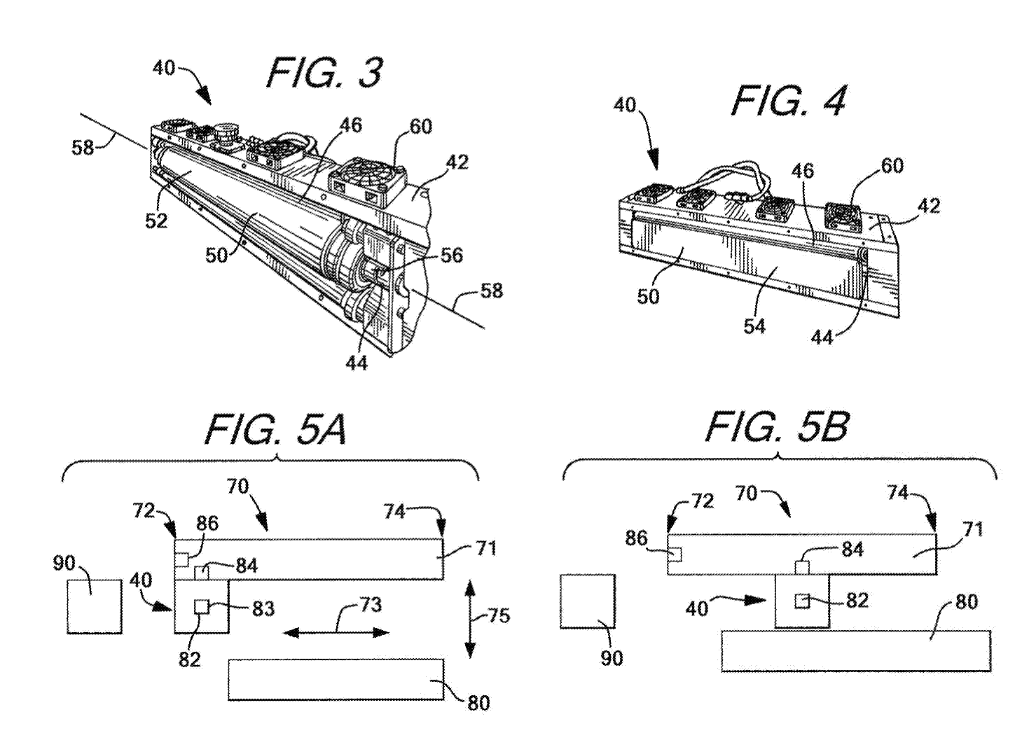

FIGS. 3 and 4 show a fabric compressor assembly 40 having a housing 42 defining a chamber 44 with an opening 46 to provide access to a surface contact member 50. The surface contact member 50 can be a roller 52 (FIG. 3) or a flat iron 54 (FIG. 4). The roller 52 is journaled at opposed ends 56 for rotation about an axis of rotation 58. The roller 52 can rotate in response to a motive force, such as a motor (not shown), or rotate in response to being moved in contact with a surface such as a textile. The housings 52 have side walls, and end walls, a top wall, and vent openings through one of the sidewalls and exhaust fans 60 for removing heat from the housings 42. While four fans 60 are shown spaced along a length dimension of the housing, a different number of vents and fans could be used, and could be positioned elsewhere on the housing, without departing from the scope of the present invention.

FIGS. 5A,5B show the fabric compressor assembly 70, separate from a printing press as a stand-alone unit, and mounted on a surface 71 for reciprocal translational movement along a first line 73 (horizontal as shown), from a first position 72 to a second position 74 and then back to the first position 72. FIG. 5A shows the fabric compressor 40 in the first position 72 and FIG. 5B shows the fabric compressor 40 in a location intermediate of the first and second positions 72,74. The fabric compressor can be moved between the first and second positions manually or automatically using a motive force. The fabric compressor can be positioned manually by an operator during a setting-up procedure in a vertical direction to contact the object support with a desired pressure or to pass over the textile at a desired distance but not contacting the textile. The object support can also be positioned vertically with respect to the fabric compressor instead of moving the fabric compressor. An operator of the press can move the fabric compressor by hand back and forth between the first position 72 and the second position 74.

The fabric compressor 40 can optionally be mounted for automatic movement using a first member 84 to move the fabric compressor along the first line 73 back and forth between the first position 72 and the second position 74. A second member 86 is shown for moving the fabric compressor along the second line 75 back and forth between the engaged position and the disengaged position. One example of such controls are those used to move a squeegee bar and flood bar in an automated screen printing press. During a printing operation, the squeegee is moved vertically downward into engagement with a screen at a desired pressure and the flood bar is moved vertically upward and is not in contact with the screen. The squeegee and flood bar are moved together from the first position to the second position over an area known as the printing area. This is known in the industry as a print stroke. When moving from the second location to the first location, the vertical movement of these elements is reversed and the squeegee is moved upward out of contact with the screen and the flood bar is moved downwardly in contact with the screen. The squeegee and the flood bar are then moved along the first line 73 from the second position to the first position. This is known in the industry as the flood stroke.

The fabric compressor 40 can be automatically, vertically positioned to contact or be in near contact in any desired fashion and is not limited to the print stroke and flood stroke mentioned above. The fabric compressor can be programmed to contact the textile during movement from the first location to the second location and during the return trip from the second location to the first location. The fabric compressor can be programmed to apply one pressure to a textile in one leg of the trip and another pressure during the opposing leg. The fabric compressor can also be programmed to make several trips between the first and second location as desired. In one preferred aspect, the fabric compressor will operate like the squeegee bar and be in contact with a screen interposed between the textile and the roller, or moved at a desired distance therefrom, and in the return trip from the second location to the first location be positioned spaced from the screen and not in contact therewith. More preferably, fabric compressor will be directly exposed to the textile without the use of a screen interposed between the textile and the fabric compressor. The roller will be either in direct contact with the textile or will be in sufficient proximity to heat the textile.

The fabric compressor assembly 70 has a heater element 82 and a temperature sensor 83 to maintain the roller 50 at the desired temperature. The desired temperature can be ambient temperature up to 400° F. (204° C.). A controller 90 (FIG. 7) is connected to the heater element 82 and has inputs 98 for setting the desired temperature, and a status section 92 for displaying the actual temperature measured by the temperature sensor 83. The controller 90 is capable of generating a signal representative of the desired temperature and sending the signal to the heater element 82, and for receiving a signal from the temperature sensor of the actual temperature of the roller 50.

FIG. 6 shows the fabric compressor assembly 70 as a station in screen printing press 10. There are numerous varieties of suitable screen printing presses 10 including automatic and manual varieties. Suitable screen printing presses include, for example, those sold by M&R Companies under the tradenames STRYKER™, CHALLENGER®, GAUNTLET®, SPORTSMAN®, DIAMONDBACK™, VICTORYONE®, PREDATOR™, PRE-RUNNER™ ALPHA 8™, KRUZER™, SIDEWINDER™, CHAMELON®, and ABACUS™. The fabric compressor assembly 70 can be used on textiles prior to printing or after. The roller 52 of the fabric compressor can directly contact and apply heat and pressure to the textile or can work through a screen interposed between the roller and the textile. In one aspect, the screen is a PTFE screen. The fabric compressor can also be passed over the textile in sufficient proximity to heat the textile without contacting it or applying pressure to the textile. This process can be used to cure or partially cure ink.

FIGS. 6 and 7 show the control unit 90 attached to a front end of a printhead arm 24 and has a multifunctional display (FIG. 7). The control unit 90 has a status section 92 having a display 94, such as an LCD display for example, an input area 96 having controls 98, and a power section 99 for turning the fabric compressor on or off. The control 90 allows for a user to select the type of contacting member either a roller or a flat iron. The control 90 also allows for a user to select the desired temperature of the contacting member 50. The display 94 shows the desired temperature of the contacting member and the actual temperature. The control unit can also be programmed to allow for entry and display of other operating parameters such as the speed of moving the fabric compressor assembly from the first location 72 to the second location 74, the speed of the return trip from the second position to the first position, whether the fabric compressor contacts the surface and if so the desired pressure to apply to the textile. The speed of moving from the engaged to the disengaged position and the return trip can also be allowed for through appropriate programming of the control. The control unit 90 also has a port 100 that allows for electrically coupling the control unit 90 to the fabric compressor assembly 70 to control the temperature of the contacting member and any combination of the operating parameters mentioned. In one form, a military grade electrical connector 102 is used and has high-cycle flexible wiring, and a long-life flexible sheath to connect the port 100 on the control 90 to a similar port 104 on the fabric compressor assembly.

In one form of the invention, the fabric compressor 70 is connected to the squeegee mounting bar 30 with two clamps 110, and the existing squeegee and flood bar controls 106 that are part of the printing press can be used to control the movement of the fabric compressor. The fabric compressor 70 can be programmed to contact the textile, applying heat and pressure (pressure stroke) to the textile only when moving from the first location to the second location or from the second location to the first location and lifted in the opposing stroke (non-pressure stroke). The fabric compressor assembly 70 can be programmed to apply pressure during both outgoing and incoming strokes or in any number of pressure strokes and non-pressure strokes. The fabric compressor 70 can also be programmed to pass the contacting member in close proximity to the textile in a heating stroke.

The fabric compressor assembly 70 can be used in numerous printing operations to address problems that commonly occur during a screen printing operation. For example, one problem known as fibrillation occurs when a printed textile appears faded or fuzzy immediately after printing or upon washing one or more times. Fibrillation is due to fibers of the textile sticking out through the printed area to give a faded or fuzzy look. The laundering process can cause fibers to pop up that are not fully coated with ink thus reducing the sharpness of the printed image and making it look fuzzy or hairy. Using the fabric compressor assembly 70 to apply heat and pressure in a pressure stroke or pressure strokes to the textile prior to applying ink presses down the fibers to reduce the tendency for them to pop up later.

The fabric compressor can also be used after ink has been applied to a textile. For example, after applying a base coat the fabric compressor can be used to smooth out the ink to give a uniform surface for subsequent printing operations and provide a printed textile with a softer hand feel of the printed surface. The fabric compressor can also be used in a foil transfer process to cause the foil to more firmly adhere to the textile over the entire surface of the foil. The fabric compressor can also be used in a curing process of heat-discharge inks in a heating stroke. In this process, the fabric compressor can be passed over the textile in sufficient proximity to heat the textile but without contacting the textile.

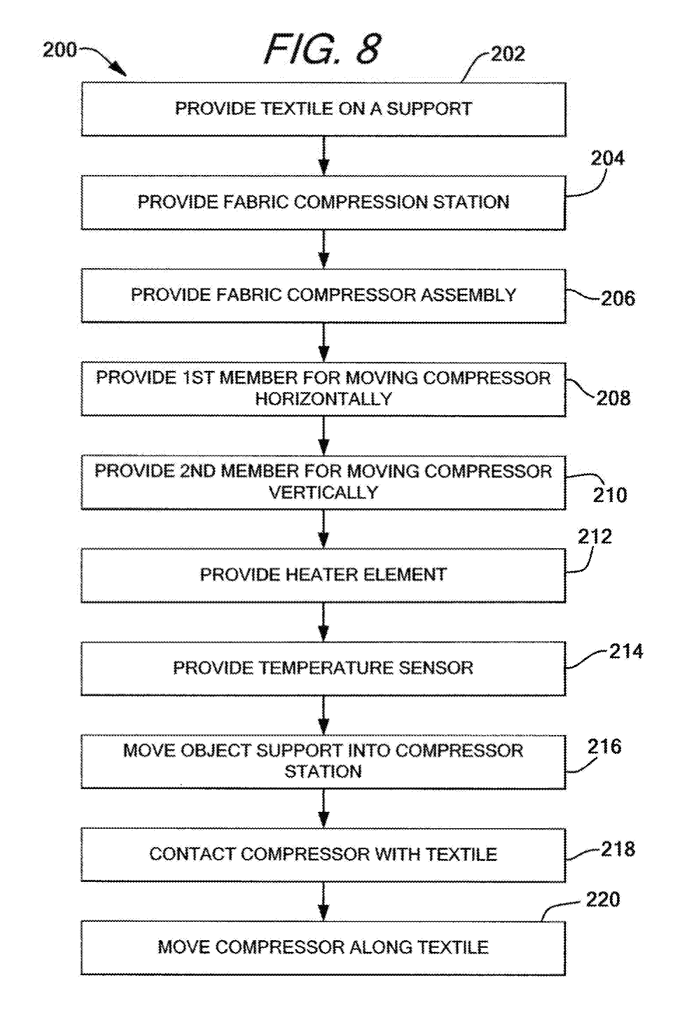

FIG. 8 shows the steps in a process 200 of treating a textile before or during a screen printing press operation. The process steps do not necessarily have to be performed in the exact order shown. In a step 202 a textile is provided on an object support surface. In a step 204, a fabric compressor station is provided having a bar extending across a portion of the object support. In step 206 provides a fabric compressor assembly mounted to the bar for translational motion along a portion thereof, the fabric compressor having a roller facing the object support. In step 208 provides a first member for moving the fabric compressor between a first position and a second position (horizontally) along the bar. In step 210 provides a second member for moving the fabric compressor or the object support along a line generally perpendicular to the bar (vertically) from a disengaged position to an engaged position. In step 212 provides a heater element connected to the roller. In step 214 provides a temperature sensor connected to the roller. In step 216 the object support is moved into the fabric compressor station. In step 218 the roller is moved into contact with or close proximity to the textile to heat the textile with the second member. In step 220 the roller is moved along the textile from the first position to the second position.

Many modifications and variations of the present invention are possible in light of the above teachings. It is, therefore, to be understood within the scope of the appended claims the invention may be protected otherwise than as specifically described.

I/We claim:

1. A fabric compressor for a screen printing press having a squeegee mounting bar comprising:
a housing having a roller and an attachment member for mounting the housing to the squeegee mounting bar for reciprocal translational motion along a first line between a first location and second location, and along a second line generally perpendicular to the first line from a disengaged position to an engaged position where the roller is in contact with a substrate or in sufficient proximity to heat the substrate;
a heater element connected to the housing for heating the roller; and
a control unit connected to the heater element having an input area and a status area, the input area having controls for setting a desired temperature of the roller and the status area having a display for indicating the actual temperature of the roller.

2. The fabric compressor of claim 1 wherein the roller is mounted within the housing for rotational movement about an axis generally perpendicular to the first direction.

3. The fabric compressor of claim 2 wherein the housing has an opening and a portion of the roller can be accessed through the opening.

4. The fabric compressor of claim 3 wherein the roller rotates about the axis during movement of the housing from the first location to the second location.

5. The fabric compressor of claim 4 wherein the roller rotates in response to contact with the substrate.

6. The fabric compressor of claim 4 further comprising a motor for rotating the roller about the axis.

7. The fabric compressor of claim 1 wherein the control unit has inputs for setting the speed for moving the housing from the first location to the second location.

8. The fabric compressor of claim 7 wherein the control unit has inputs for the speed for moving the housing along the second direction.

9. The fabric compressor of claim 1 wherein the control unit has inputs for specifying the pressure applied by the roller to the substrate.

10. The fabric compressor of claim 1 wherein the control unit has inputs for specifying the distance from the heating element to the substrate when moving the housing from the first location to the second location.

11. The fabric compressor of claim 1 wherein the housing has a heat vent.

12. The fabric compressor of claim 11 further comprising a fan mounted over the heat vent.

13. The fabric compressor of claim 1 wherein the desired temperature is from ambient temperature to 400° F. (204° C.).

14. An assembly for treating a textile before or during a screen printing operation comprising:
an object support for supporting a textile;
a bar extending across a portion of the object support;
a fabric compressor mounted to the bar for reciprocating translational motion along a portion thereof between a first position to a second position, the fabric compressor having a roller facing the object support;
a first member for moving the fabric compressor between the first position and the second position;
a second member for moving the fabric compressor or the object support along a line generally perpendicular to the bar back and forth between a disengaged position and an engaged position;
a heater element connected to the roller;
a temperature sensor connected to the roller; and
a control unit connected to the heater element and capable of generating a signal to the heater element representative of a desired temperature of the roller.

15. The assembly of claim 14 further comprising an endless conveyor and the object support attached to the conveyor and moveable with the conveyor along a path.

16. The assembly of claim 15 further comprising a plurality of print heads spaced from one another long the path, each of the plurality of print heads are connected to a source of ink and have an applicator for applying the ink to the textile.

17. The assembly of claim 14 wherein the control unit is capable of generating a signal to the second member representative of the desired pressure for the roller to apply to the textile or a distance to maintain from the textile.

18. The assembly of claim 14 wherein the desired temperature is from ambient temperature to 400° F. (204° C.).

19. The assembly of claim 14 wherein the textile has a printing area having a length dimension and a width dimension, the roller spans the width dimension and the length dimension is between the first location and the second location so that the roller contacts the entire print area in a single pass from the first location to the second location.

20. The assembly of claim 19 wherein the roller is mounted for rotation about a second axis in response to contact with the textile during movement from the first position to the second position.
